(19) United States
(12) Patent Application Publication
(10) Pub. No.: US 2008/0099580 A1
(43) Pub. Date: May 1, 2008

(54) Firefighter's mop-up knozzle

(76) Inventors: Darryl Royce Gunter, Todo Santos (MX); George William Gray, San Antonio, TX (US)

Correspondence Address: Charles W. Hanor, 750 Rittiman Road, San Antonio, TX, 78209, US

(21) Appl. No.: 12/004,237

(22) Filed: Dec. 20, 2007

Related U.S. Application Data
(63) Continuation of application No. 11/233,251, filed on Sep. 21, 2005, now abandoned.
(60) Provisional application No. 60/612,244, filed on Sep. 22, 2004.

(51) Int. Cl. A62C 3/00; A62C 31/22

(52) U.S. Cl. 239/271; 169/54

(57) ABSTRACT

The present invention is an apparatus to be connected to the end of a fire hose that will allow a nozzle operator to perform mop-up fire fighting work without a shovel man and to extinguish both below-ground pockets of smoldering material and small surface fires. The apparatus incorporates a low-pressure, air-aspirated nozzle mounted on an elongated conduit that can be used for both the above-ground and below-ground work, can be used with fire foam, can extend the useful reach of fire hose equipment and can lengthen the use time for a given volume of water contained in a portable tank. Mop-up work refers to the process of extinguishing smoldering pockets of compacted organic material on and below the ground and small flare-ups that remain after the primary surface fire of a forest or grassland fire has swept through an area or been extinguished.

### CROSS-REFERENCE TO RELATED APPLICATIONS

This application claims priority to U.S. Provisional Patent No. 60/612,244, filed Sep. 22, 2004.

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

This invention relates generally to fighting forest and grassland fires and specifically to performing the post-fire clean-up work, known as mop-up work, by extinguishing smoldering pockets of compacted organic material on and below the ground surface and extinguishing small surface fires that remain after the flames of the large surface fire have passed through the area.

2. Description of the Related Art

Bowl-shaped undulations and depressions in the ground exist in all areas covered by forests and grasslands. Over time, these depressions fill with compacted layers of combustible organic material such as pine needles, leaves, twigs and other plant matter. When a fire sweeps through a forest or grassland, these combustible materials are ignited, and because the layers are compacted, the material burns very slowly and can smolder for days or weeks after the main fire has been extinguished, increasing the potential for rekindling the fire anew. The depressions of smoldering material are known as “hot spots” and the work of completely extinguishing the hot spots is part of the post-fire clean-up work known as “mop-up” work.

Traditionally, firefighters work in two-man crews for mop-up operations. One firefighter (hereinafter referred to as the shovel man) has a shovel, and the other firefighter (hereinafter referred to as the nozzle operator) carries a fire hose. To extinguish a hot spot, the nozzle operator first sprays the ground layer of a hot spot with water. The shovel man then digs out two or three inches of the smoldering organic material. The nozzle operator sprays the excavated material and the surface of the two or three inch deep hole with water. The shovel man then digs out another two or three inches of smoldering material and the process is repeated. Since a hot spot can be several feet deep, this process can be very slow and time-consuming.

This two-man mop-up crew is also responsible for extinguishing small surface fires of smoldering tree stumps, snags, branches and other wood lying on the ground within their area of responsibility. However, to add to the inefficient nature of mop-up work, while the nozzle operator is diverting his attention (and his nozzle) to dousing a small surface fire, the shovel man is essentially idle. While a mop-up area could be served by three-man teams, which would include the two-man crew extinguishing hot spots and an additional nozzle operator to address surface fires, this would involve double the equipment, including an extra hose and an extra source of water. Therefore, any manpower efficiency gained is offset by less efficient use of equipment.

### BRIEF SUMMARY OF THE INVENTION

The present invention seeks to increase the efficiency of mop-up work by providing an apparatus and method that eliminates the need for the shovel man, thereby allowing mop-up work to be done as a one-man operation. There are several key design elements which allow the apparatus to be used as a one-man operation. In order to eliminate the shovel man, the apparatus incorporates a nozzle tip which will jet away dirt and debris. Since the fire site of a forest or grassland fire is often remote, the water volume and pressure available to a firefighting crew is limited by the type of equipment (i.e. trucks and water tanks) that can access the remote site. Therefore, the nozzle tip of the present apparatus converts a relatively low pressure water supply into a high pressure stream of water capable of washing solid material away.

In addition, the nozzle tip is also designed to allow the operator to extinguish above ground fires. To accomplish this task, the nozzle tip is preferably an air-aspirating nozzle tip with sufficient throw distance to propel water onto a fire at a safe distance. To further increase the efficiency of fire extinguishing capabilities of the apparatus, the nozzle tip also has the ability to combine foam concentrate and water to create with aspirated air to create an air-aspirated fire foam, which is significantly more effective at extinguishing fires than water alone.

Furthermore, because of the desirability to have a single-man mop-up crew in a remote, and often rugged, area, the apparatus incorporates features which make it portable and easy to use. The apparatus includes a device to control water flow. The apparatus also provides a swivel to eliminate the problem of a hose tangling with the apparatus and constraining the movement of the operator. The apparatus also incorporates a lightweight and compact design which makes it easy for a single person to carry for extended periods of time. And lastly, the lightweight design of the apparatus does not come at the expense of its durability.

Finally, the design of the apparatus is straight-forward so that a fire department can easily request from a manufacturer an apparatus which is customized to that fire department's particular situational and equipment constraints.

### BRIEF DESCRIPTION OF THE SEVERAL VIEWS OF THE DRAWINGS

FIG. 1. Side view of the apparatus.

FIG. 2. Side view of the apparatus being used to extinguish below-ground smoldering material.

### DETAILED DESCRIPTION OF THE INVENTION

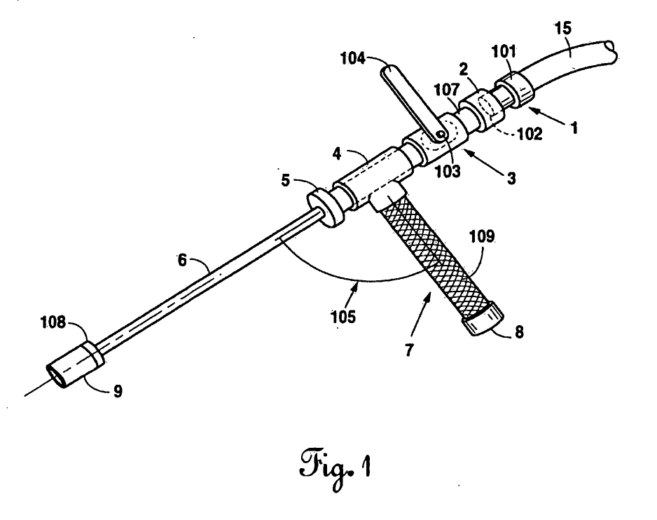

FIG. 1 shows the assembled components of the Mop-Up Apparatus. The major components include a releasable hose connector 1 that may be threaded, or of the quick release type. The releasable hose connector is releaseably connected to a water supply hose 15 that is connected to a water supply. The releasable hose connector 1 is connected to a swivel connection 2 to allow the apparatus to be rotated and positioned relative to the hose 15. A valve assembly 3 is also connected to the pipe conduit 107. The valve assembly 3 includes a value operator 104 which allows the operator to control the flow of water through the apparatus. The valve assembly 3 is connected to an elongated and extending pipe conduit 6 that is long enough to position the end of the operator grip away from the end of the apparatus air-aspirating exit nozzle 9 during use on hot-spots. An operator's handle grip 7 is positioned on the apparatus next to the valve assembly 3 to enable the operator to position, control and apply the apparatus to extinguish a hot spot. Attached to the end of conduit 6 is an air-aspirating nozzle tip 9 used to inject a foamed water into a hotspot to extinguish a fire.

The hose connector 1 and swivel 2 are considered upstream components of the apparatus and extending pipe 6 and nozzle tip 9 are considered downstream components. In various embodiments of the invention, the upstream components may have a higher cold water working pressure than the downstream components. Cold water working pressure signifies the amount of water pressure that a component can withstand. For instance, a cold water working pressure of 600 pounds per square inch indicates that a component is rated to withstand sustained water pressures of 600 pounds per square inch when the water is at a temperature of less than 150 degrees Fahrenheit. Forest and grassland firefighting crews normally use water from natural water sources or portable water tanks; it would be highly unusual that the water is hotter than 150 degrees Fahrenheit. Furthermore, cold water working pressure is distinguishable from the bursting pressure of a component, which is normally about four-hundred percent (400%) higher than the cold water working pressure. Bursting pressure is defined as the internal water pressure which will stretch the components to the point at which they will crack and leak.

The threaded hose connector 1 will have an upstream thread or connector 101 and a downstream thread or connector 102. The upstream thread or connector 101 will be capable of releasably connecting onto a hose 15 used in fighting forest or grassland fires. The downstream thread or connector 102 will connect to the swivel 2. In addition, the threaded hose connector 1 will have a cold water working pressure sufficient to withstand high internal water pressures within the apparatus. One particular embodiment that provides interoperability with standard fire hoses will have a three-quarter-inch, female NH fire hose thread or connector on the upstream end and a one-half-inch, male-tapered pipe thread or connector on the downstream end. The size of the threaded hose connector is based on the diameter of the fire hose with which it is to be used. In this embodiment, the adapter has a cold water working pressure of 1,200 pounds per square inch.

The swivel 2 allows the apparatus to rotate independently from hose connector 1 and attached hose 15. This will keep the apparatus and operator from becoming entangled in the hose and hence will allow the operator to have a full range of motion while extinguishing smoldering material and moving from one hot-spot to another. The swivel may connect directly to the downstream thread or connector 102 of the hose connector 1. Alternatively, these pieces can be connected by means of a small connecting pipe (not shown). While the apparatus is not constrained by the material of which the swivel is made, one embodiment uses a stainless steel swivel. As compared to a plated steel swivel, a stainless steel swivel will weigh less without sacrificing durability. In one embodiment, the swivel has a cold water working pressure of 3,500 pounds per square inch.

The downstream end of the swivel 2 will connect either directly, or by way of a connecting pipe 107 to the valve assembly 3. The valve assembly 3 allows the operator to quickly and accurately control the flow of water to the nozzle tip. The valve assembly 3 comprises a ball valve 103 and a valve handle 104. Other types of valves may be used. The valve handle 104 is rotated to control the aperture position of ball valve 103. The valve assembly 3 divides the upstream components from the downstream components. This location will prevent the downstream components from being subjected to a sudden rise in water pressure inside the fittings that may result if the nozzle operator inadvertently moves valve handle 104 from the full-open position to the full-closed position in a fraction of a second. This sudden spike in water pressure is known in the art as the “water hammer” affect. In a preferred embodiment of the apparatus, ball valve 103 has a cold water working pressure of 600 pounds per square inch and the downstream components have a cold water working pressure of at least 300 pounds per square inch.

The valve assembly 3 will connect at its downstream end to elongated extending pipe 6, either directly or through reducing connector 5 and connecting Tee 4. If a reducing connector is used, it is considered a downstream component and must meet the minimum cold water working pressure rating of the apparatus. The extending pipe 6 serves three primary purposes. First, it allows the operator to bring nozzle tip 9 in contact with the ground while standing. Second, it allows the operator, by pushing on grip 7, to push or force nozzle tip 9 into a pile or depression filled with burning or smoldering material to a sufficient depth to ensure that the below-ground fire is completely extinguished. Third, when the operator is using the apparatus to extinguish above ground fires, extending pipe 6 permits the operator to stand a safe distance away from the fire and to direct the flow of water accurately toward the fire. In a preferred embodiment of the apparatus, the extending pipe is generally at least 48 inches in length

The apparatus also comprises an operator's handle 7. The operator's handle 7 may be attached either to the connecting Tee 4 (as shown in FIG. 1), extending pipe 6, or valve assembly 3. The operator's handle 7 is of sufficient length to provide an adequate area for the operator's gloved hand to grip the handle. In addition, the outer circumference of the operator's handle must be within a range to permit the operator's gloved hand to fit comfortably around the handle. If the circumference is either too large or too small, the operator's grip on the handle will be compromised. The handle 7 will extend at angle 105 from lateral line 106 of the apparatus' main body. This angle 105 may be a 90-degree angle or may be any angle which provides additional ease of use or control of the apparatus. The handle may also comprise an end cap 8 to ensure that the operator's hand does not slide off of the grip of 109 of handle 7. The handle 7 may be connected to reducing connector 5 or extending pipe 6 by means of connecting Tee 4.

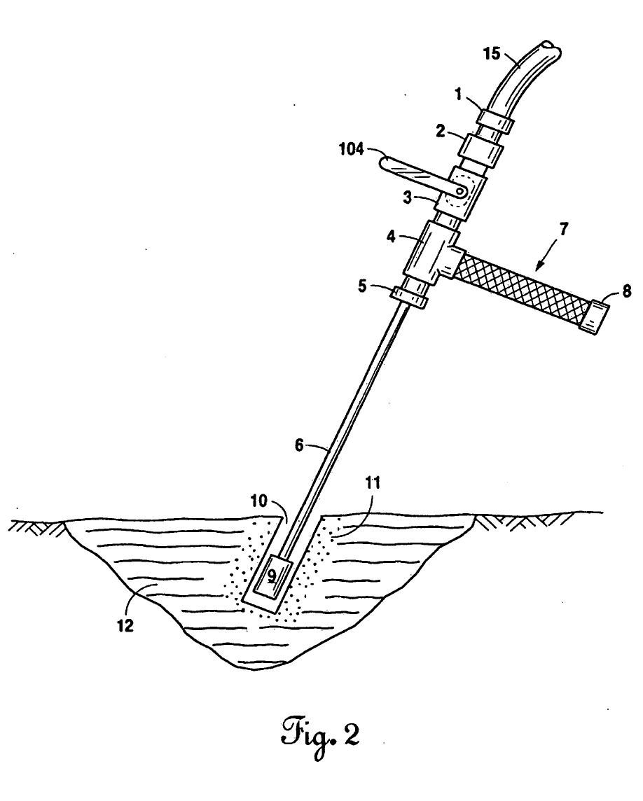

The nozzle tip 9 is an air-aspirating foam nozzle tip that is connected, by way of threads 108, onto the downstream end of extending pipe 6. The nozzle tip emits a solid stream of liquid (water or foam) in the same direction as lateral line 106 of the apparatus body. In use, this stream of water will wash away debris and dirt in its direct path and thus effectively dig or wash out a hole 10, shown in FIG. 2, from the smoldering organic material 12 left after a forest or grassland fire. The extent to which a nozzle can wash away solid materials is directly related to the force of the water that is supplied to and emitted from the nozzle. The nozzle tips used in the present invention are designed to provide adequate force to wash away solid materials even at relatively low water pressures. Experiments with an actual embodiment of the present invention have dug holes in solid dirt at water supply pressures of less than 40 pounds per square inch. It generally takes more time to wash out a hole with lower water pressures.

Present embodiments provide nozzle tips with a variety of pressure characteristics. Some, but not all, of these variety of nozzle tips are referenced in the remainder of this description; therefore, the inclusion or exclusion of a nozzle tip rating is not intended to limit the scope of the invention.

Taken as a whole, the apparatus is extremely portable. In one embodiment, the entire apparatus weighs less than 3.6 pounds and is less than 58 inches long. While field experiments with the above embodiment have demonstrated adequate durability for use in the rugged and remote areas in which forest fires occur, the use of alternative materials may result in improvements in durability for certain types of uses. The components of the apparatus can be made of a wide variety of durable and corrosion-resistant materials, including, but not limited to stainless steel, aluminum, galvanized steel, galvanized malleable iron or brass. The present invention is not limited by the materials used for the components of the apparatus.

To operate apparatus, the operator, as shown in FIG. 2, positions nozzle tip 9 on top of smoldering, below-ground debris 12 (hard clay soil or deep deposits of pine needles, leaves, twigs, tree branches, tree bark, tree roots, sawdust, or other smoldering or burning plant matter) that is to be extinguished. The operator will then turn valve handle 104 releasing a stream of liquid (water or foam solution) into debris 12. The operator does not need to exert much downward force on the apparatus to bore or wash a hole in the debris. Rather the force of the stream of liquid will wash out a hole 10 in the debris that is slightly larger in diameter than the diameter of nozzle tip 9. The operator must exert only enough force to keep the apparatus from recoiling from the force of the water pressure and to wash out the debris. As hole 10 is bored or washed out, it will fill with water or foam solution, which will also penetrate or seep into the area of debris 11 surrounding the bored hole 10. As the hole is bored or washed out deeper, the operator may need to pull the nozzle upward a few inches to promote improved penetration and saturation of the debris. The operator can continue boring the same hole up to the depth of the extending pipe, if necessary. When one hole and the surrounding area have been sufficiently saturated to extinguish the smoldering debris, the operator may remove nozzle tip 9 and extending pipe 6 from the hole and repeat the operation until the entire hot spot is extinguished. Therefore, the invention allows a nozzle operator to extinguish a hot spot without the aid of a shovel man.

The air-aspirating foam nozzle tip will also allow fire foam to be used to combat both the below-ground and above-ground fires. Foam concentrate is a type of liquid soap that is sold commercially, usually in five gallon containers. Class A foam concentrate is the type used to fight forest and grassland fires. Class A foam concentrate is added to water to create a foam solution which can be pumped through a hose. If the foam solution is injected by the air-aspirating nozzle tip into a below-ground area, air is not present and the foam solution is not mixed with air. This foam solution is more effective than water at saturating and extinguishing below-ground debris. If the foam solution is sprayed into the air, the air-aspirating nozzle tip will mix the solution with air to produce a wet, air-aspirated fire foam, which is ten times more effective at extinguishing fires in wood and other cellulose materials than water. Furthermore, the nozzle tips used in the present invention provide sufficiently high throw distances, even at relatively low water pressures, to combat above-ground fires from a safe distance. (The horizontal throw distances shown in Table 1 for the various nozzle types is defined as the horizontal distance a water or air-aspirated fire foam stream will reach when the nozzle tip 9 is pointed upward at an angle of 30 degrees above horizontal). Therefore, it is not necessary for an operator to change nozzles or equipment to combat both above-ground and below-ground fires.

TABLE 1

| Nozzle | Pressure at the Nozzle Tip in pounds per square inch (PSI) | | | |
|---|---|---|---|---|
| Tip Size | 40 PSI | 100 PSI | 200 PSI | 300 PSI |
| 6 | 27 feet | 34 feet | 39 feet | 41 feet |
| 7 | 30 feet | 38 feet | 43 feet | 45 feet |
| 8 | 31 feet | 40 feet | 46 feet | 48 feet |
| 9 | 33 feet | 42 feet | 48 feet | 51 feet |
| 10 | 34 feet | 44 feet | 50 feet | 53 feet |
| 11 | 36 feet | 46 feet | 53 feet | 56 feet |
| 12 | 38 feet | 49 feet | 56 feet | 59 feet |

The use of a low-pressure, low-flow rate nozzle also increases the efficiency of mop-up operations by reducing some inherent firefighting limitations. The first limitation is access to water. When a crew is far from a natural water source, they will need to transport water to the work area in a portable water tank. This transport is a time-consuming process. If the useful life of a single tank of water can be extended, it can dramatically affect the efficiency of the mop-up operations. Because the nozzle tip can operate at lower water pressures, the crew can use a lower flow rate to accomplish the same amount of mop-up work. At a lower flow rate, a water tank of a given volume can be used for a longer period of time before being refilled. Table 2 shows the flow rate (in gallons per minute) for the different nozzle tip sizes at four different nozzle tip pressures.

TABLE 2

| Nozzle | Pressure at the Nozzle Tip in pounds per square inch (PSI) | | | |
|---|---|---|---|---|
| Tip Size | 40 PSI | 100 PSI | 200 PSI | 300 PSI |
| 6 | 0.6 gpm | 1.0 gpm | 1.3 gpm | 1.6 gpm |
| 7 | 0.8 | 1.3 | 1.8 | 2.2 |
| 8 | 1.0 | 1.6 | 2.2 | 2.7 |
| 9 | 1.5 | 2.4 | 3.4 | 4.1 |
| 10 | 2.0 | 3.2 | 4.5 | 5.5 |
| 11 | 2.5 | 4.0 | 5.6 | 6.9 |
| 12 | 3.0 gpm | 4.7 gpm | 6.7 gpm | 8.2 gpm |

Secondly, since the crew's work is tied to the water supply, its movement is limited by the length of hose that can be used. A smaller diameter hose is lighter and hence a longer length of hose can be pulled through the work area. However, smaller diameter hoses are susceptible to a greater loss of water pressure over the length of the hose; therefore, the length of a small diameter hose run is limited not by weight but by pressure loss. (See Table 3). Since the nozzle tip used with the present invention is effective at lower water pressures, the device can absorb a greater water pressure loss attributable to smaller diameter hoses and hence allows a longer length of a smaller diameter hose to be used.

TABLE 3

| | Hose Diameter | | |
|---|---|---|---|
| Flow rate | ⅝ inch | ¾ inch | 1 inch |
| (gallons/min) | diameter hose | diameter hose | diameter hose |
| 1 | 0.4 PSI per | 0.2 PSI per | 0.1 PSI per |
| | 100 feet | 100 feet | 100 feet |
| 2 | 1.4 | 0.7 | 0.1 |
| 3 | 3.2 | 1.5 | 0.3 |
| 4 | 5.8 | 2.5 | 0.6 |
| 5 | 9.0 | 3.8 | 0.9 |
| 6 | 13.0 | 5.3 | 1.3 |
| 7 | 17.6 | 7.1 | 1.7 |
| 8 | 23.0 | 9.2 | 2.2 |

Furthermore, because of the variety of nozzle tips which can be used with the present invention, a manufacturer can customize the apparatus to meet the operational and situational needs of a particular fire department or crew. For instance, a fire department in a remote area may have a pickup truck with a 100 gallon water tank, a pump with a discharge pressure of 100 pounds per square inch (PSI), and 1,000 feet of ¾-inch diameter fire hose and 1,000 feet of ⅝-inch diameter fire hose that they want to connect to form one 2,000 feet long hoseline. The fire department may limit the flow rate to 2 gallons per minute. At two gallons per minute, Table 3 shows the friction loss in 1,000 feet of ¾-inch hose is 7 PSI and the loss in 1,000 feet of ⅝-inch hose is 14 PSI, for a combined total friction loss of 21 PSI. With a 100 PSI pump, the pressure at nozzle tip 9 will be 100 PSI minus 21 PSI or 79 PSI. Table 1 shows the size “9” nozzle tip will provide a flow of about 2 gallons per minute when the nozzle tip pressure is 79 PSI.

Because the apparatus is portable and has the ability to combat above-ground fires using a low-volume water supply and a low-pressure pump, the invention is also useful for controlling pasture burning and other small prescribed fires.

Thus has been described an apparatus to be used to extinguish below-ground and above-ground fires that linger after the surface flames of a forest or grassland fire have passed through an area. Although the description above contains examples of specific embodiments of the invention, these descriptions are provided for illustrative purposes only and are not meant to limit the scope of the invention. The scope of the invention should be limited only by the appended claims and their equivalents.

We claim:

1. A fire suppression apparatus comprising:
a detachable nozzle tip having the means for converting a portable liquid supplied at low pressure to a high pressure, low flow rate stream, including threads to attach to the downstream end of the elongated pipe and emitting the stream away from the elongated pipe along the longitudinal axis of the elongated pipe, also including means for combining supplied liquid with aspirated air and emitting an air-aspirated stream;
an elongated pipe having the nozzle tip attached by threads at the downstream end and having means for attaching a liquid supply hose at the opposite end of the elongated pipe from the nozzle tip;
the liquid solution comprising water and a foam concentrate suitable for application to a fire of organic materials;
a ball valve and handle connected to the elongated pipe for controlling the flow of a liquid solution from the liquid supply to the nozzle tip to allow the liquid solution pressure to wash out a hole in smoldering and burning solid, organic debris;
a handle connected at an opposing angle to the elongated pipe to allow an operator to carry and accurately position the nozzle tip to extinguish fires while flowing a fire extinguishing liquid solution from the attached liquid supply through the elongated pipe and nozzle tip to wash out a hole in smoldering and burning solid, organic debris to allow the extinguishing liquid solution to be injected to put out fires below the surface of the debris;
the extending pipe having sufficient length to allow the operator, while in a standing position, to bring the nozzle tip in contact with the ground and inject liquid solution in smoldering and burning solid, organic debris;
the means for attaching the hose further comprises a means to allow the apparatus to rotate independently from the hose;
the components of the apparatus are made of material not susceptible to rust; and
the upstream components have a cold water working pressure of at least 1200 pounds per square inch and the means for controlling the flow of liquid has a cold water working pressure of 600 pounds per square inch.

2. (canceled)

3. (canceled)

4. (canceled)

5. (canceled)

6. (canceled)

7. (canceled)

8. (canceled)

9. (canceled)

10. (canceled)

11. (canceled)
